(19) United States
(12) Patent Application Publication
(10) Pub. No.: US 2005/0094861 A1
(43) Pub. Date: May 5, 2005

(54) Positional synchronization in a multivoting character recognition environment

(75) Inventors: Ravinder Prakash, Concord, NC (US); Madhura Sathe, Charlotte, NC (US); Rodney G. Moon, Charlotte, NC (US); Robert W. Kruppa, Bluffton, SC (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/698,735

(22) Filed: Oct. 31, 2003

(51) Int. Cl. G06K 9/00; G06K 9/18; G06K 9/36

(52) U.S. Cl. 382/137; 382/182

(57) ABSTRACT

A system and method for providing positional synchronization of characters in a multi-voting character recognition system. The system comprises a character recognition system, comprising: at least one transducer system for scanning printed character data and generating a plurality of sets of transduced character information; a position collection system for collecting positional data for characters in the plurality of sets of transduced character information; a character position synchronization system for positionally synchronizing corresponding characters from different sets of transduced character information; and a voting engine for receiving the plurality of sets of transduced character information.

### BACKGROUND OF THE INVENTION

1. Technical Field

The present invention relates generally to character recognition systems, and relates more specifically to a system and method for providing positional synchronization of characters in a multivoting character recognition system.

2. Related Art

Character recognition systems have become an integral part of many of today's business operations. Character recognition systems are utilized in applications wherein printed character data must be converted to electronic information. There exist a number of character recognition technologies, with some of the most popular being optical character recognition (OCR) and magnetic ink character recognition (MICR).

Unfortunately, character recognition systems are often prone to errors due to numerous factors, including inconsistencies in the print quality, inconsistencies in the paper quality, etc. One way to improve the efficacy of character recognition systems is to obtain multiple sets of read results for each character being read. Then a “voting” engine can be utilized to analyze corresponding sets of read results to provide higher recognition accuracy or increased read rate.

Each set of read results can be obtained from different transducer technologies (e.g., OCR and MICR) and/or from using variations within the same technology, e.g., using different gray-scale levels in an OCR read. For instance, in an OCR environment, a gray-scale image may be “thresholded” many times to generate a series of black and white images. The series of black and white images can form multiple instances of character data suitable for analysis by a voting engine. Results from a MICR read can likewise be added to further increase the read rate.

One of the problems that occur when read information is obtained from multiple transducer inputs is that the characters from the different inputs may not be positionally synchronized. There exist certain circumstances in which the read data for one or more inputs includes a missed character or an erroneously added character. This problem takes potentially serious shape when results from different sets of transduced information are combined by the voting engine. For example, consider the case where a first set of transduced information correctly includes a string of characters and a second set erroneously does not include the third character read from a string of characters. In this case, the second set of transduced information will provide character information that is not synchronized with the first set. Namely, it will report that the fourth character is the third character, the fifth character is the fourth character, and so on. The result is a situation where characters obtained from different sets of corresponding transduced information are not positionally synchronized with each other.

Accordingly, without a mechanism for addressing this problem, the use of multiple read data and voting engines will be subject to unintentional misreads.

### SUMMARY OF THE INVENTION

The present invention addresses the above-mentioned problems, as well as others, by providing a character recognition system and method that provides positional synchronization of characters in a plurality of corresponding sets of transduced character information. In a first aspect, the invention provides a character recognition system, comprising: at least one transducer system for scanning printed character data and generating a plurality of sets of transduced character information; a position collection system for collecting positional data for characters in each set of transduced character information; a character position synchronization system for positionally synchronizing corresponding characters from different sets of transduced character information; and a voting engine for receiving the positionally synchronized sets of transduced character information.

In a second aspect, the inventions provides a character recognition system, comprising: a position collection system for collecting positional data for a plurality of corresponding sets of transduced character information; and a character position synchronization system for positionally synchronizing characters from the corresponding sets of transduced character information.

In a third aspect, the invention provides a method for providing character recognition in which multiple sets of corresponding transduced character information are analyzed by a voting engine, comprising: scanning printed character data to generate multiple sets of corresponding transduced character information; collecting positional data for characters in the sets of corresponding transduced character information; and positionally synchronizing characters from the sets of corresponding transduced character information.

In a fourth aspect, the invention provides a program product stored on a recordable medium for facilitating character recognition in a multi-voting character recognition engine, comprising: means for collecting positional data for a plurality of corresponding sets of transduced character information; and means for positionally synchronizing character information from the corresponding sets of transduced character information.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a character recognition system in accordance with the present invention.

FIG. 2 depicts an exemplary system for obtaining positional data from an image of a bank check.

FIG. 3 depicts a first and second set of transduced character information having related positional data.

### DETAILED DESCRIPTION OF THE INVENTION

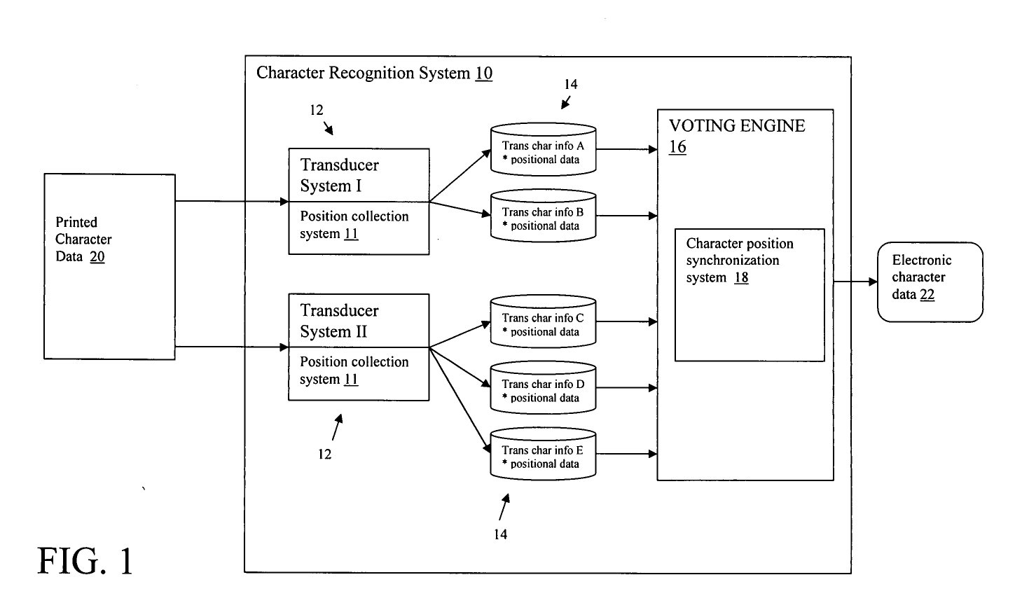

Referring now to the drawings, FIG. 1 depicts a multi-voting character recognition system 10 that reads in printed character data 20 and generates electronic character data 22. Character recognition system 10 includes one or more transducer systems 12 for generating multiple sets of transduced character information 14, and a voting engine 16 that processes multiple sets of transduced character information 14 in order to minimize errors in the generated electronic character data. As noted above, voting engines, which are known in the art and are therefore not described in detail herein, analyze multiple instances of the same character data in order to improve read results and reduce misreads.

In the example provided in FIG. 1, two transducer systems (I and II) 12 are utilized to generate five corresponding sets of transduced character information 14, i.e., transducer system I generates sets A and B, and transducer system II generates sets C, D and E. Each set includes different instances of the same character information, and each set of transduced character information 14 may include a single character, a plurality of characters, etc. It is understood that the number and type of transducer systems, as well as the number of sets of transduced character information 14 generated can vary without departing from the scope of the invention. Each transducer 12 generally includes: (1) a transducer device, such as an optical or magnetic ink reader that scans in character data; and (2) a processing system which, for example, is capable of generating multiple instances or corresponding sets of transduced character information 14. For example, an OCR processing system may generate several data sets derived at different gray-scale level settings.

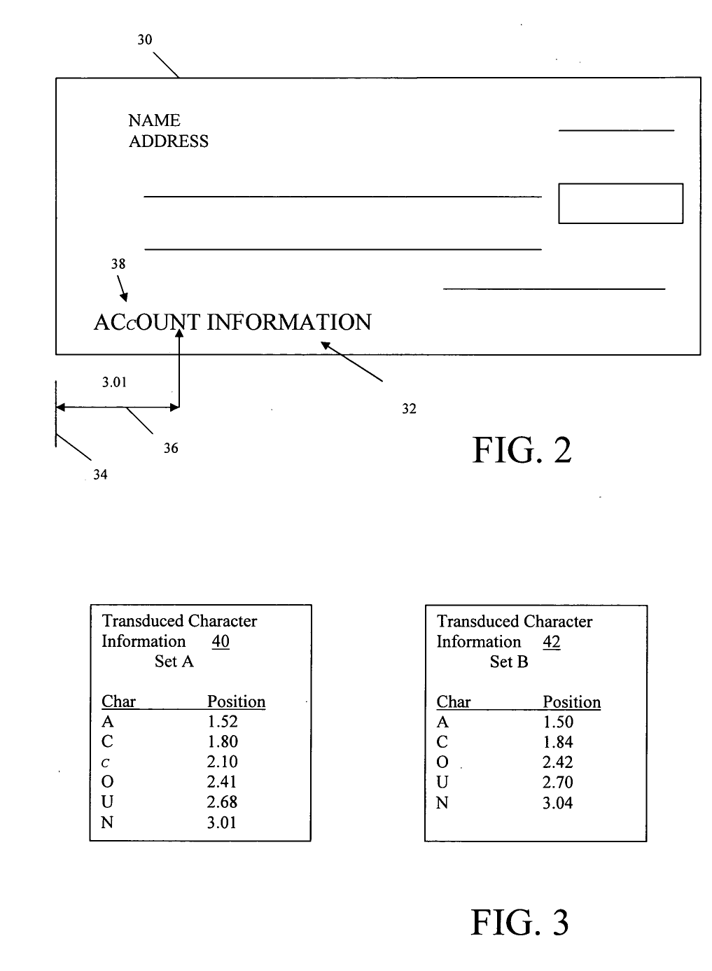

Character recognition system 10 further includes one or more position collection systems 11. Each position collection system 11 collects positional data associated with the character data collected by the transducer systems 12. An exemplary methodology for collecting positional data is described below with respect to FIG. 2. However, it should be noted that the positional data could be obtained in any manner by any type of device, and may be obtained before, during or after the scanning process.

Positional data is stored along with each set of transduced character information 14. Two examples of transduced character information 14 that include positional data are described below with reference to FIG. 3. Transduced character information 14, and the associated positional data, can be stored in any manner, e.g., in RAM, in temporary cache, in a buffer, on a disk, etc., or be fed directly to voting engine 16.

As noted above, and described in further detail below with regard to FIG. 2 and 3, situations may arise wherein characters from corresponding sets of transduced character information 14 get out of synchronization. To overcome this problem, character recognition system 10 includes a character position synchronization system 18 for positionally synchronizing corresponding characters from different sets of transduced character information 14. Character position synchronization system 18 utilizes the positional data associated with each set of transduced character information 14 to ensure that the voting engine 16 processes the correct characters from each set. Character position synchronization system 18 can perform this synchronization either as part of the voting process, or separately. Typically, synchronization would be implemented as a separate function before the voting occurs.

In the case where different transducers are utilized, multiple instances of positional information for a printed character string are collected/derived from the different transducers. In such cases, as in the described embodiment of using a MICR and an optical system, it may be necessary to initially synchronize the positional information for each instance of the captured character string. Stated alternately, a reference point for the two (or more) position transducers needs to be aligned, i.e., a positional bias must be established.

The positional bias may be calculated, e.g., by first establishing the character read synchronization for the first few characters and then calculating the average positional bias of the multiple instances of the string.

In an exemplary embodiment, a stepper motor, which transports document in relatively small steps, can be utilized to provide positional information. Specifically, stepper information may be mapped into a linear displacement of a document in order to provide positional data. Knowing when the MICR characters are read in relationship to the motor steps, a MICR “positional string” can be established. Similarly, the optical positional string can be established by knowing the character position in pixel counts and the pixels per unit length of the optical imaging system. Knowing the two positional strings in units of length, the bias of one with respect to the other(s) is established by then synchronizing the “read” of the first few, e.g., 3 or 4, characters.

Referring now to FIG. 2, an exemplary implementation for obtaining positional data from a document 30 is shown. Document 30 comprises a check that includes various printed indicia, including account information 32 currently being read by a character recognition system in accordance with the invention. In this example, characters from the account information 32 are being scanned in from left to right by one or more transducer systems 12, and two sets of corresponding transduced character information, sets A and B, are generated and stored in buffers 40 and 42, as shown in FIG. 3. In addition, position collection system 11 captures positional data for the character information. Positional data may include any type of information that relates to a spatial location of the character information.

In the above example, positional data comprises a position measurement 36 for each character by position collection system 11. As shown in FIG. 2, the position measurement comprises a distance from the character to a reference point, in this case, the left edge 34 of the check 30. Thus, for example, the character “N” has a position measurement of 3.01 cm as determined in positional data Set A. It is understood that any point or points on document 30 (and/or some other external fixed point(s)) could be used as a reference point for collecting positional data for the transduced character information. Moreover, to increase precision, the position measurement can be based on a particular location within each character, e.g., the right or left edge of the character, a middle point of the character, etc. Thus, for instance, the position measurement associated with each character may comprise the distance between a middle point of the character and the left edge of the document.

As seen in FIG. 3, the position measurement for each read character for both sets of transduced character information is stored with the characters in buffers 40 and 42. For instance, the first set of transduced character information A, C, C, O, U, and N is stored with position measurements 1.52, 1.80, 2.10, 2.41, 2.68 and 3.01 respectively in buffer 40. The second set of transduced character information A, C, O, U, and N is stored with position measurements 1.52, 1.84, 2.42, 2.70 and 3.04 respectively in buffer 42.

Note that in the exemplary document of FIG. 2, the third character “c” 38 in the account information 32 was incorrectly printed. While the first set A of transduced character information correctly captured the character data, the second set B skipped the third character altogether. Thus, the second set B only includes the character information A, C, O, U and N. Without the positional data, the two sets of transduced character information would be out of synchronization, i.e., set A would list “U” as the fifth character, while set B would list “N” as the fifth character. Accordingly, without positional data, voting engine 16 would end up trying to resolve characters from two different spatial positions, resulting in a likely misread.

Instead, character recognition system 10 includes character position synchronization system 18 to positionally synchronize corresponding sets of transduced character information 14. Specifically, positional data is analyzed to ensure that voting engine 16 is voting on character information obtained from the same position on document 30. Thus, each character in a set is positionally synchronized with characters from other corresponding sets.

In one exemplary embodiment, synchronization is achieved as follows. First one set of the character information (e.g., Set A) is established as the reference set. Next, each position measurement value from the reference set is compared to position measurement values from the secondary set(s) (e.g., Set B). If a position measurement value from one of the secondary sets matches the position measurement value from the reference set, within some tolerance, then it is concluded that the characters associated with the matching position measurement values correspond. For instance, Char A, from the reference Set A has a position measurement value of 1.52. This value is then compared to each value in the secondary Set B to look for matches within a tolerance (e.g., +/−0.05). In this case, Char A from secondary Set B from has a value of 1.50, which falls within the tolerance range. It is thus concluded that Char A from reference Set A corresponds to Char A from the secondary Set B (i.e., the two characters from sets A and B can be synchronized). Obviously, the selection of the tolerance range can vary from application to application.

This process is then repeated for each character in the reference Set A to identify corresponding characters in the secondary set(s). Thus, it can be seen that the second character “C” having a value of 1.80 in Set A corresponds to the second character “C” in Set B, which has a value of 1.84. Note however that in Set A, the third character “c” has a positional data value of 2.10, and no positional data value in Set B matches 2.10 (i.e., the closest value is 1.84, which is a 0.26 difference and falls outside the tolerance of +/−0.05). Accordingly, it is concluded that there is no corresponding character in Set B for the third character “c.” It can be readily seen that the remaining characters in the reference Set A, “O, U & N” having values of 2.41, 2.68 and 3.01 respectively, correspond to characters “O, U & N” in secondary Set B, which have values of 2.42, 2.70 and 3.04, respectively. That is, their respective values fall within the tolerance.

In this example, after positional synchronization of buffers 40 and 42, two positionally synchronized buffers could be created as follows:
Set A buffer=[A, C, c, O, U, N]
Set B buffer=[A, C, *, O, U, N]
   Wherein the * indicates that no data is available for that character in Set B. Obviously, numerous variations of using positional data to synchronize data among multiple sets of transduced character data could be implemented, and fall within the scope of the invention. Once the character information from corresponding sets are synchronized, voting engine 16 can analyze each corresponding set of transduced character information to generate electronic character data 22.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A character recognition system, comprising:
at least one transducer system for scanning printed character data and generating a plurality of sets of transduced character information;
a position collection system for collecting positional data for characters in each set of transduced character information;
a character position synchronization system for positionally synchronizing corresponding characters from different sets of transduced character information; and
a voting engine for receiving the positionally synchronized sets of transduced character information.

2. The character recognition system of claim 1, comprising an optical character recognition (OCR) transducer and a magnetic ink character recognition (MICR) transducer.

3. The character recognition system of claim 1, wherein the at least one transducer system generates a plurality of sets of transduced character information based on different gray-scale level settings.

4. The character recognition system of claim 1, wherein the position information system generates a position measurement for each character in the at least one set of transduced character information, wherein each position measurement provides a distance from the character to a predetermined location on a document containing the printed character data.

5. The character recognition system of claim 4, wherein the predetermined location includes an edge of the document.

6. The character recognition system of claim 4, wherein each position measurement provides a distance from a middle point of the character to the predetermined location.

7. The character recognition system of claim 4, wherein the character position synchronization system determines if characters from different sets of transduced characters correspond to each other by matching the position measurement of the characters in different sets, within a predetermined tolerance.

8. A character recognition system, comprising:
a position collection system for collecting positional data for a plurality of corresponding sets of transduced character information; and
a character position synchronization system for positionally synchronizing characters from the corresponding sets of transduced character information.

9. The character recognition system of claim 8, further comprising at least one transducer system for scanning printed character data and generating the corresponding sets of transduced character information.

10. The character recognition system of claim 9, wherein the at least one transducer system generates a plurality of corresponding sets of transduced character information based on different gray-scale level settings.

11. The character recognition system of claim 8, further comprising a voting engine for processing the corresponding sets of transduced character information.

12. The character recognition system of claim 8, wherein the position information system generates a position measurement for each character in each set of transduced character information, wherein each position measurement provides a distance from the character to a predetermined location on a document containing the printed character data.

13. The character recognition system of claim 12, wherein the predetermined location includes an edge of the document.

14. The character recognition system of claim 12, wherein each position measurement provides a distance from a middle point of the character to the predetermined location.

15. The character recognition system of claim 12, wherein the character position synchronization system ensures that corresponding characters from corresponding sets of transduced character information have the same position measurement, within a predetermined tolerance.

16. A method for providing character recognition in which multiple sets of corresponding transduced character information are analyzed by a voting engine, comprising:
scanning printed character data to generate multiple sets of corresponding transduced character information;
collecting positional data for characters in the sets of corresponding transduced character information; and
positionally synchronizing characters from the sets of corresponding transduced character information.

17. The method of claim 16, wherein the step of collecting positional data provides a position measurement for each character in the sets of corresponding transduced character information, and wherein each position measurement provides a distance from the character to a predetermined location on a document containing the printed character data.

18. The method of claim 17, wherein the position measurement provides a distance from the character to an edge of the document.

19. The method of claim 17, wherein the step of positionally synchronizing characters includes the step of determining if characters from different sets of transduced characters correspond to each other by comparing the position measurement of the characters.

20. A program product stored on a recordable medium for facilitating character recognition in a multi-voting character recognition engine, comprising:
means for collecting positional data for a plurality of corresponding sets of transduced character information; and
means for positionally synchronizing character information from the corresponding sets of transduced character information.

21. The program product of claim 20, wherein the positional data comprises a position measurement for each character in each set of transduced character information, wherein each position measurement provides a distance from the character to a predetermined location on a document.

22. The program product of claim 21, wherein the means for positionally synchronizing character information ensures that corresponding characters from corresponding sets of transduced character have the same position measurement, within a predetermined tolerance.
